(19) United States
(12) Patent Application Publication
(10) Pub. No.: US 2009/0195934 A1
(43) Pub. Date: Aug. 6, 2009

(54) DEVICE AND METHOD FOR MANUFACTURING SPRING MEMBER

(75) Inventors: Toshikazu Furui, Kawasaki (JP); Naohisa Matsushita, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/335,932

(22) Filed: Dec. 16, 2008

(30) Foreign Application Priority Data
Feb. 1, 2008 (JP) 2008-022355

(51) Int. Cl. G11B 21/16; B21D 37/16; B23K 26/00

(52) U.S. Cl. 360/244.8; 219/121.76; 219/121.85; 72/342.94; 29/603.12; G9B/21.023

(57) ABSTRACT

A spring member manufacturing device that manufactures the spring member by laser irradiation includes a laser irradiation unit including a plurality of laser irradiation devices that perform predetermined laser irradiation with respect to the spring member. In the spring member manufacturing device, the laser irradiation devices are configured so that laser irradiated conditions different from each other are preset for the respective laser irradiation devices, and are arranged so that the respective irradiated positions do not overlap each other. The laser irradiation apparatus is constituted by combining laser irradiation devices having laser irradiation conditions being 2 to the (n−1)th power, n being a positive integer,of predetermined minimum adjustment amount for adjusting load on the spring member. The combination of the laser irradiation devices are selected in accordance with load adjusting amount required for the spring member.

### BACKGROUND

1. Field of the Invention

The present technique relates to a device and method for manufacturing a spring member.

2. Description of the Related Art

A magnetic storage device performs recording/replay of information on a magnetic disk by positioning a head slider floated by a rotation of the magnetic disk, on a track. Such a magnetic storage device has an actuator for positioning the head slider on the track. The actuator includes a head slider having an electromagnetic transducer, a suspension mounting thereon the head slider, and an arm supporting the suspension. The suspension includes a load beam, which is a spring member made of stainless, and a flexure unit disposed at an edge unit of the load beam and mounting the head slider.

Two forces act on the head slider. A first force is a load applied by the suspension. A second force is an aerodynamic lift that occurs by an air flow generated by rotation of the magnetic disk passing through a rail unit of an air bearing surface (ABS) adjacent to the magnetic disk surface, of the head slider, and that tries to separate the head slider from the magnetic disk surface. In a state wherein the head slider maintains a definite flying amount under the balance between these two forces, the head slider is positioned at a predetermined track position, whereby recording/replay is performed. In such a magnetic storage device, the flying amount of the head slider influences the property of the magnetic head. Therefore, an achievement of a target flying amount is implemented by adjusting a load applied to the suspension within a predetermined standard range in the manufacturing stage of the suspension.

As a method for adjusting a load on the suspension, for example, a method is used in which the load beam is irradiated with laser. This is a method for adjusting the load within the predetermined standard range by deforming the load beam to thereby increase/decrease the load (refer to Japanese Laid-open Patent Publication No. 2002-260358).

In order to adjust the load by applying laser, it is necessary to impart an irradiation amount according to a load adjustment amount on the suspension. For this purpose, a single laser irradiation device reciprocates a plurality of times on the suspension to perform laser irradiation. As a result, idle running time of the laser irradiation device increases, so that takt time undesirably varies depending on the load adjustment amount in device operations in a factory.

### SUMMARY

It is an object of the present technique to provide a device and method for manufacturing a spring member for reducing the variations of the takt time when manufacturing the spring member.

According to an aspect of an embodiment, a device for manufacturing the spring member comprises a laser irradiation apparatus including a plurality of laser irradiation devices for performing predetermined laser irradiation with respect to the spring member. The laser irradiation devices is arranged to eliminate overlap with respective irradiated position on the spring member. The laser irradiation devices have preset laser irradiation condition different from each other. The irradiation condition is 2 to the (n−1)th power, n being a positive integer,of predetermined minimum adjustment amount for adjusting load on the spring member. The combination of laser irradiation devices are selected in accordance with a spring load adjusting amount required for the spring member.

### BRIEF DESCRIPTION OF THE DRAWINGS

FIGS. 1A and 1B are diagrams showing a magnetic storage device;

FIG. 2 is a block diagram of a spring member manufacturing device according to the present embodiment;

FIGS. 3A and 3B are diagrams showing measurement of a suspension, according to the present embodiment;

FIG. 4 is a diagram of laser irradiation units according to the present embodiment;

FIG. 5 is a diagram showing a layout of laser irradiation devices according to the present embodiment;

FIGS. 6A to 6I are diagrams showing irradiated positions on the suspension, according to the present embodiment;

FIG. 7 is a block diagram of a control unit according to the present embodiment;

FIG. 8 is a diagram showing load adjustment process according to the present embodiment; and

FIG. 9 is a diagram showing a specific example of load correction according to the present embodiment.

### DESCRIPTION OF THE PREFERRED EMBODIMENTS

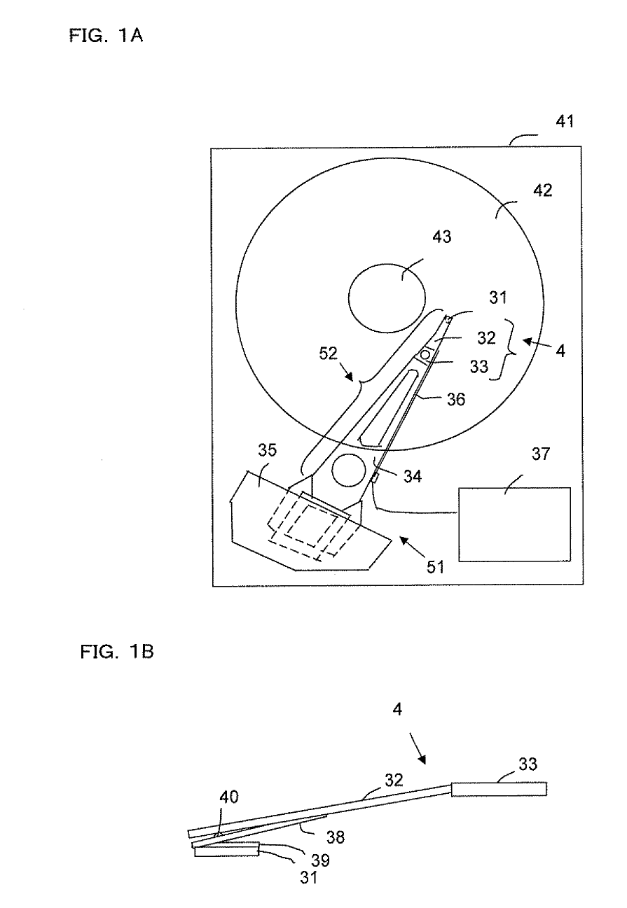

FIGS. 1A and 1B are diagrams showing a magnetic storage device. FIG. 1A shows an outline of the magnetic storage device 41.

The magnetic storage device 41 includes a magnetic disk 42, a spindle motor 43 for rotating the magnetic disk 42, and an actuator 51 that mounts thereon a magnetic head performing writing/reading of information in/from the magnetic disk 42.

The actuator 51 includes an actuator block 52 and a drive unit 35 driving the actuator block 52. The actuator block 52 includes a suspension 4 that mounts thereon the head slider 31 having the magnetic head, and an arm 34 supporting the suspension 4. A flexible printed circuit board 36 connected to the magnetic head is attached to the side surface of the actuator block 52. The flexible printed circuit board 36 is connected to a control circuit (not shown) via a fixing member 37. The control circuit rotationally drives the actuator block 52 by a drive unit 35, and positions the magnetic head on a predetermined track on the magnetic disk 42, thereby performing writing/reading of information.

FIG. 1B is an explanatory diagram of the suspension 4.

The suspension 4 includes a load beam 32, a flexure 38, and a spacer unit 33. The load beam 32 is a spring member, to which the flexure 38 is connected. A gimbal 39 for mounting the head slider 31 is provided at the front end of the flexure 38.

The load on the load beam 32 operates on the head slider 31 mounted on the gimbal 39 by a pivot 40 formed on the load beam 32. By this load counterbalancing with a flying force of the head slider 31, the magnetic head can maintain a predetermined floating position. The spacer unit 33 is soldered to the load beam 32, and crimped with the arm 34 in the actuator block 52.

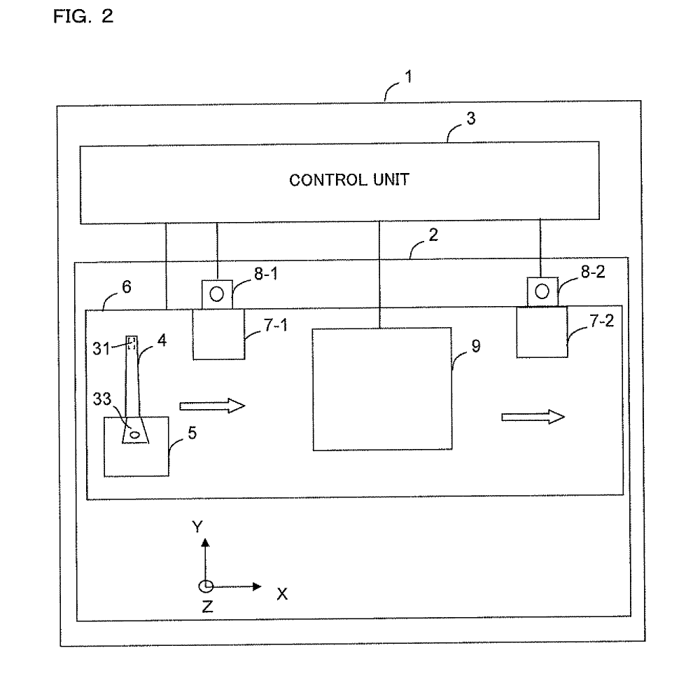

FIG. 2 is a block diagram of a spring member manufacturing device according to the present embodiment.

The spring member manufacturing device 1 is a device for adjusting a spring load on the suspension 4, in the manufacturing process for the suspension 4. The spring member manufacturing device 1 includes a load adjustment unit 2 and a control unit 3.

The load adjustment unit 2 measures a load on the suspension 4. If the measured load is without the standard range, the load is adjusted. For this purpose, the load adjustment unit 2 includes the suspension 4, a fixing unit 5, a conveying unit 6, a load meter 7-1, a load meter drive unit 8-1, a laser irradiation unit 9, a load meter 7-2, and a load meter drive unit 8-2. The fixing unit 5 holds the spacer unit 33 of the suspension 4. In a state where the spacer unit 33 is held, the back surface of the load beam 32 is placed face up, and the surface thereof is placed face down. Here, the “surface” of the load beam 32 refers to a face mounting the head slider 31, while the “back surface” of the load beam 32 refers to a face not mounting the head slider 31. The conveying unit 6 drives the fixing unit 5 along an X-direction so that the suspension 4 can be subjected to load measurement and laser irradiation.

The load meter 7-1 and the load meter 7-2 are measurement devices for measuring a load by measuring distortion of the suspension 4, generated e.g., by depression. The load meters 7-1 and 7-2 are each disposed at a predetermined position. Notification of measured results are provided to the control unit 3.

When the suspension 4 mounted on the fixing unit 5 is set on the conveying unit 6, it is conveyed to the load meter 7-1. As a result, the suspension 4 is positioned above the load meter 7-1. Next, the load meter 7-1 is moved up by the load meter drive unit 8-1, and measures a load on the suspension 4. Here, the “load” on the suspension 4 refers to a spring pressure against the head slider 31 by the load beam 32.

Then, the suspension 4 mounted on the fixing unit 5 is conveyed to the load meter 7-2 by the conveying unit 6, after the suspension 4 having been subjected to laser irradiation. As a result, the suspension 4 is positioned above the load meter 7-2. Next, the load meter 7-2 is moved up by the load meter drive unit 8-2, and measures a load on the suspension 4.

The load meter drive unit 8-1 moves the load meter 7-1 along a Z-direction (direction perpendicular to a plane constituted by the X-direction and a Y-direction in FIG. 2) so as to make contact with the suspension 4. The load meter drive unit 8-2 moves the load meter 7-2 along a Z-direction so as to make contact with the suspension 4. The laser irradiation unit 9 applies a laser output to at least one predetermined position on load beam 32 of the suspension 4 with a predetermined heat amount, with a load adjustment amount being made be matched.

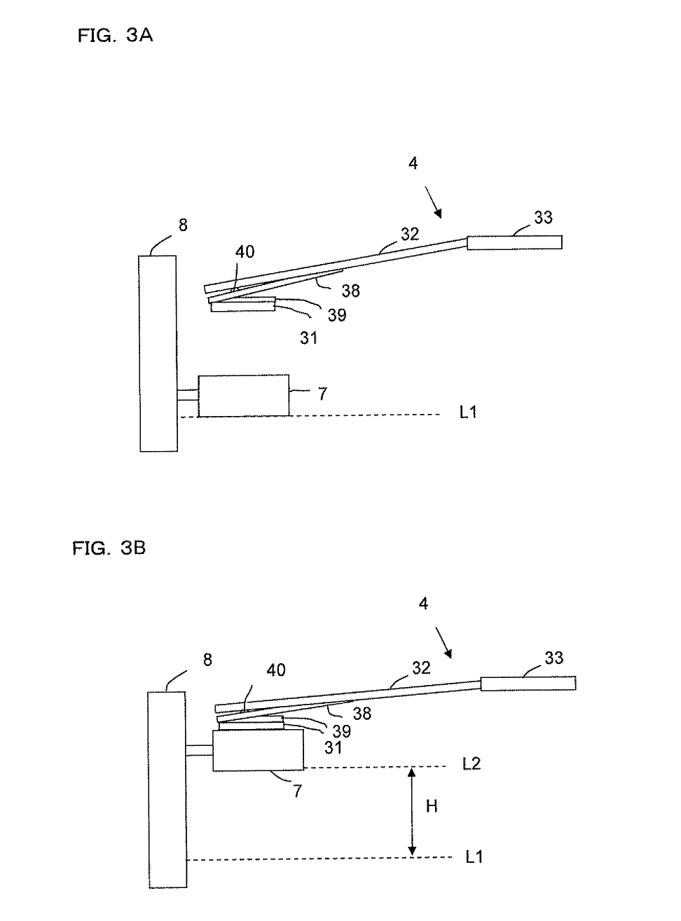

FIG. 3 is an explanatory diagram of measurement of the suspension.

FIG. 3A shows a positional relation between an initial position of the load meter 7 and the suspension 4. Here, L1 indicates the initial position of the load meter 7. The suspension 4 is set above the load meter 7.

FIG. 3B shows a position when the load meter 7 has been moved up a predetermined distance H from L1 to L2 by the load meter drive unit 8. This position shows a position when the head slider 31 of the suspension 4 moves up to a target flying position. A value of the load meter 7 at this time is acquired. This moving distance H is a value calculated in advance on the basis of the position of the spacer unit 33 and that of the position L1 of the load meter 7.

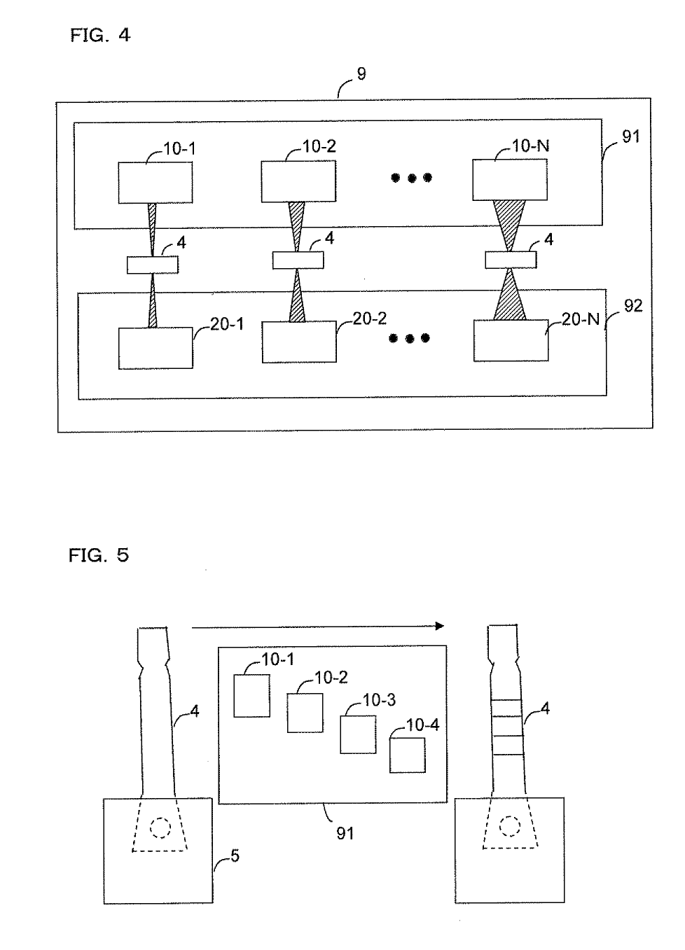

FIG. 4 is an explanatory diagram of the laser irradiation unit. The laser irradiation unit 9 includes a surface irradiation unit 91 and a back-surface irradiation unit 92. Here, the “surface” refers to a face mounting the head slider 31, of the suspension 4. On the other hand, the “back surface” refers to a face not mounting the head slider 31, of the suspension 4.

The surface irradiation unit 91 irradiates the surface of the suspension 4, the surface being the face mounting the head slider 31. The irradiation here is a radiation along a direction in which the load increases.

The surface irradiation unit 91 includes laser irradiation device 10-1 to laser irradiation device 10-N. The laser irradiation device 10-1 to 10-N are sequentially arranged in the order from the laser irradiation device 10-1 to the laser irradiation device 10-N along the X direction, which is the conveying direction of the fixing unit 5. Here, N is a positive integer.

A laser irradiation adjustment amount of the laser irradiation device 10-1 is m×1 [g], that of the laser irradiation device 10-2 is m×2 [g], . . . , that of the laser irradiation device 10-N is m×2⁽ⁿ⁻¹⁾ [g]. Here, n is a positive integer, and m is a number of minimum adjustment units of load adjustment.

The reason why such arrangement is used, is because adjustment amounts within the range from a minimum spring member to a maximum adjustment amount can be achieved by a minimum arrangement, by multiplying the adjustment amounts of the laser irradiation devices 10 by a factor of 2⁽ⁿ⁻¹⁾ on the basis of the maximum adjustment amount and the minimum adjustment amount.

Furthermore, by using a plurality of laser irradiation devices 10-1 to 10-N with such an arrangement, a predetermined irradiation amount can be obtained by a single operation. This eliminates the need to perform operations several times on the suspension 4 to obtain a predetermined irradiation amount as in the conventional art, by virtue of the laser irradiation devices 10-1 to 10-N. As a result, it is not necessary to reciprocate the conveying unit 6, thereby reducing scanning time.

Thus, since the suspension 4 is irradiated with laser by a single scan irrespective of the magnitude of an adjustment amount of the suspension 4, it can be prevented that takt time of the product manufacturing varies.

The laser irradiation device 10-1 applies laser to a position nearest the flexure 38 in an irradiation area. The laser irradiation device 10-N applies laser to a position nearest the spacer unit 33 in the irradiation area. As N increases, the irradiated position is shifted from the position nearest the flexure 38 in the irradiation area to the position nearest the spacer unit 33 in the irradiation area.

The reason why such an arrangement is employed is because, if laser is applied to a unit other than the above-described irradiated position, such as a curved unit of the load beam 32, is irradiated with laser, the focus of laser is changed to thereby vary irradiation amount.

On the other hand, the back-surface irradiation unit 92 irradiates the back surface of the suspension 4, the back surface being an opposite face of the face mounting the head slider 31. The irradiation here, therefore, a radiation along a direction in which the load decreases. The surface irradiation unit 92 includes laser irradiation device 20-1 to laser irradiation device 20-N.

The laser irradiation devices 20-1 to 20-N are sequentially arranged in the order from the laser irradiation device 20-1 to the laser irradiation device 20-N along the conveying direction of the fixing unit 5.

A laser irradiation adjustment amount of the laser irradiation device 20-1 is m×1 [g], that of the laser irradiation device 20-2 is m×2 [g], . . . , that of the laser irradiation device 20-N is m×2⁽ⁿ⁻¹⁾ [g]. Here, n is a positive integer, and m is a number of minimum adjustment units of load adjustment.

The reason why such an arrangement is used, is the same as the reason in the case of surface irradiation unit 91.

The laser irradiation device 20-1 applies laser to a position nearest the flexure 38 in an irradiation area. The laser irradiation device 20-N applies laser to a position nearest the spacer unit 33 in the irradiation area. As N increases, the irradiated position is shifted from the position nearest the flexure 38 in the irradiation area to the position nearest the spacer unit 33 in the irradiation area.

The reason why such an arrangement is employed is the same as the reason in the case of the surface irradiation unit 91.

In order to pass the suspension 4 between the mutually opposed laser irradiation devices 10 and laser irradiation devices 20 by the conveying unit 6, there are two conveying methods.

A first conveying method is a method in which the suspension 4 is moved between the mutually opposed laser irradiation devices 10 and laser irradiation devices 20 by the conveying unit 6, at a definite speed and in a one-way manner. By this conveyance, a time period during which a predetermined irradiated position on the suspension 4 is irradiated with laser becomes approximately the same. Therefore, in order to obtain a predetermined laser irradiation adjustment amount, the laser irradiation device 10-1 to 10-N, and the laser irradiation device 20-1 to 20-N that are mutually different in laser output according to the laser irradiation adjustment amount, are employed.

A second conveying method is a method in which the suspension 4 is moved between the mutually opposed laser irradiation devices 10 and laser irradiation devices 20 by the conveying unit 6, at speeds corresponding to the laser irradiation devices 10-1 to 10-N, and the laser irradiation devices 20-1 to 20-N, and in a one-way manner. In this conveyance, outputs of the laser irradiation devices 10-1 to 10-N are made to be the same. Outputs of the laser irradiation devices 20-1 to 20-N are also made to be the same. Therefore, in this method, for example, the speed is sequentially reduced in the order from the laser irradiation device 10-1 to the laser irradiation device 10-N, and consequently the laser irradiation amount is sequentially increased, whereby a predetermined laser adjustment amount is achieved.

As a result, laser light is converged onto the surface and the back surface of the suspension 4 to thereby perform scanning. Thereby, the relative positional relationship between the laser irradiation devices 10 and the laser irradiation devices 20, and correction positions of the suspension 4 becomes definite, so that stable load adjustment can be implemented.

The present technique in not limited to the method in which the suspension 4 is moved between the mutually opposed laser irradiation devices 10 and laser irradiation devices 20 by the conveying unit 6. A method can also be used in which the suspension 4 is stopped at a predetermined position, and in which the laser irradiation devices 10 or the laser irradiation devices 20 performs scanning on the suspension 4.

FIG. 5 is a diagram showing a layout of the laser irradiation device. This is an example in which laser is applied to four predetermined places of the load beam 32 on the surface of the suspension 4. Here, the laser irradiation devices 10-1 to 10-4 in the surface irradiation unit 91 are arranged to be displaced in the conveying direction of the suspension 4 and a longitudinal direction of the suspension 4.

As shown in FIG. 5, the suspension 4 is subjected to irradiation at four places by being past under the surface irradiation unit 91 by the conveying unit 6.

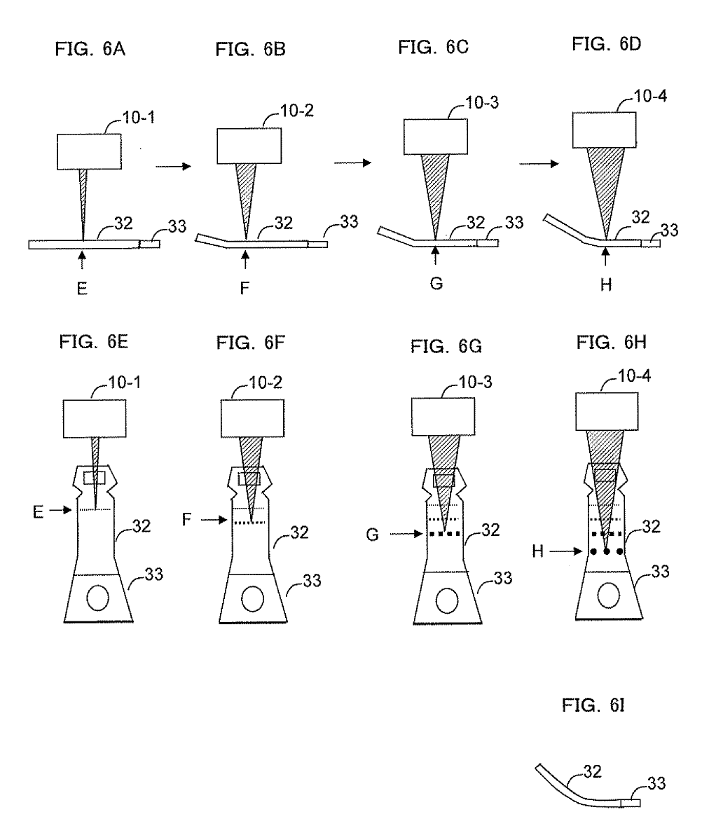

FIGS. 6A to 6i are diagrams showing irradiated positions on the suspension. This is an example in which laser is applied to four places on the surface of the suspension 4.

The load beam 32 is scanned in a widthwise direction and irradiated with laser. Upon irradiation, the irradiated unit is subjected to thermal expansion once. However, upon completion of the irradiation, after a while, temperature decreases, so that the irradiated unit contracts and bends toward the irradiated side. The bending amount increases in accordance with an increase in irradiation amount.

FIG. 6A shows a bending state of irradiated position E on the suspension 4 by the laser irradiation device 10-1, and a bending state of the suspension 4 before laser irradiation.

The irradiated position E by the laser irradiation device 10-1 is a laser irradiated position located at a position farthest from the spacer unit 33, which is located at the edge of the load beam 32. The laser irradiation adjustment amount with respect to the laser irradiated position E is m [g].

FIG. 6E shows a position on the suspension 4, the position being radiated with laser in a state shown in FIG. 6A.

FIG. 6B shows a bending state of irradiated position F on the suspension 4 by the laser irradiation device 10-2, and a bending state of the suspension 4 before laser irradiation. The suspension 4 is in a state after having subjected to laser radiation by the laser irradiation device 10-1, and has a bend that has occurred on the flexure 38 side of the suspension 4 further than the irradiated unit.

The laser irradiated position F is a position apart from the position from which the laser irradiation device 10-1 has applied laser, toward the spacer unit 33 by a predetermined distance. The laser irradiation adjustment amount with respect to the laser irradiated position F is 2m [g]. FIG. 6F shows a position on the suspension 4, the position being radiated with laser in a state shown in FIG. 6B.

FIG. 6C shows a bending state of irradiated position G on the suspension 4 by the laser irradiation device 10-3, and a bending state of the suspension 4 before laser irradiation. The suspension 4 is in a state after having subjected to laser radiation by the laser irradiation device 10-2, and has a bend that has occurred on the flexure 38 side of the suspension 4 further than the irradiated unit.

The laser irradiated position G is a position apart from the position from which the laser irradiation device 10-2 has applied laser, toward the spacer unit 33 by a predetermined distance. The laser irradiation adjustment amount with respect to the laser irradiated position G is 4m [g].

FIG. 6G shows a position on the suspension 4, the position being radiated with laser in a state shown in FIG. 6C.

FIG. 6D shows a bending state of irradiated position H on the suspension 4 by the laser irradiation device 10-4, and a bending state of the suspension 4 before laser irradiation. The suspension 4 is in a state after having subjected to laser radiation by the laser irradiation device 10-3, and has a bend that has occurred on the flexure 38 side of the suspension 4 further than the irradiated unit.

The laser irradiated position H is a position apart from the position from which the laser irradiation device 10-3 has applied laser, toward the spacer unit 33 by a predetermined distance. The position H is also a laser irradiated position located nearest the spacer unit 33. The laser irradiation adjustment amount with respect to the laser irradiated position H is 8m [g].

FIG. 6H shows a position on the suspension 4, the position being radiated with laser in a state shown in FIG. 6D.

FIG. 6I shows a bending state of the suspension 4 after the irradiated position H on the suspension 4 has been irradiated with laser by the laser irradiation device 10-4.

The purpose of arranging the laser irradiation device 10-1 to the laser irradiation device 10-N so as to be displaced in sequence as described above, is to impart laser on a flat unit on the load beam 32 to reduce variations of focus of laser light when performing laser irradiation.

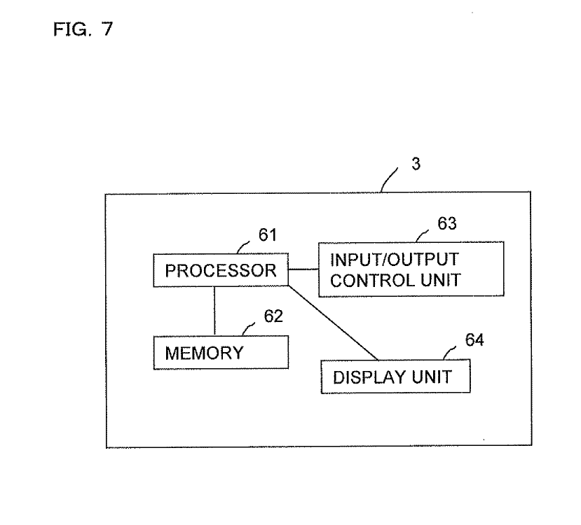

FIG. 7 is a block diagram of a control unit according to the present embodiment.

The control unit 3 controls the load adjustment unit 2 to adjust the load amount of the suspension 4. The control unit 3 includes a processor 61, a memory 62, an input/output control unit 63, and a display unit 64.

The processor 61 controls the entirety of the load adjustment unit 2.

The memory 62 stores the standard value of load, a correspondence table between loads and laser irradiation amounts, and control programs for controlling the load adjustment unit 2 operated by the processor.

The control programs includes a conveyance control program for controlling the conveying unit 6; a load measurement program for measuring the load of the suspension by driving the load meter 7; a load adjustment program that compares the load measured by the load meter 7 with a target load as the standard value, that, on the basis of the difference between the measured value and the target load, determines a load adjustment value, and that selects a combination of the above-described laser irradiation devices according to the load adjustment value; a laser irradiation program for controlling laser irradiation with respect to the suspension 4 by the selected laser irradiation devices; and a process control program for controlling processing processes.

The input/output control unit 63 controls input/output with respect to the surface irradiation unit 91 and the back-surface irradiation unit 92, the conveying unit 6, the load meter 7, the load meter drive unit 8, and the like.

The display unit 64 displays operation screens of the spring member manufacturing device 1, measurement contents of the suspension 4 in an initial state by the load meter 7, measurement contents of the suspension 4 in remeasurement by the load meter 7, and the like.

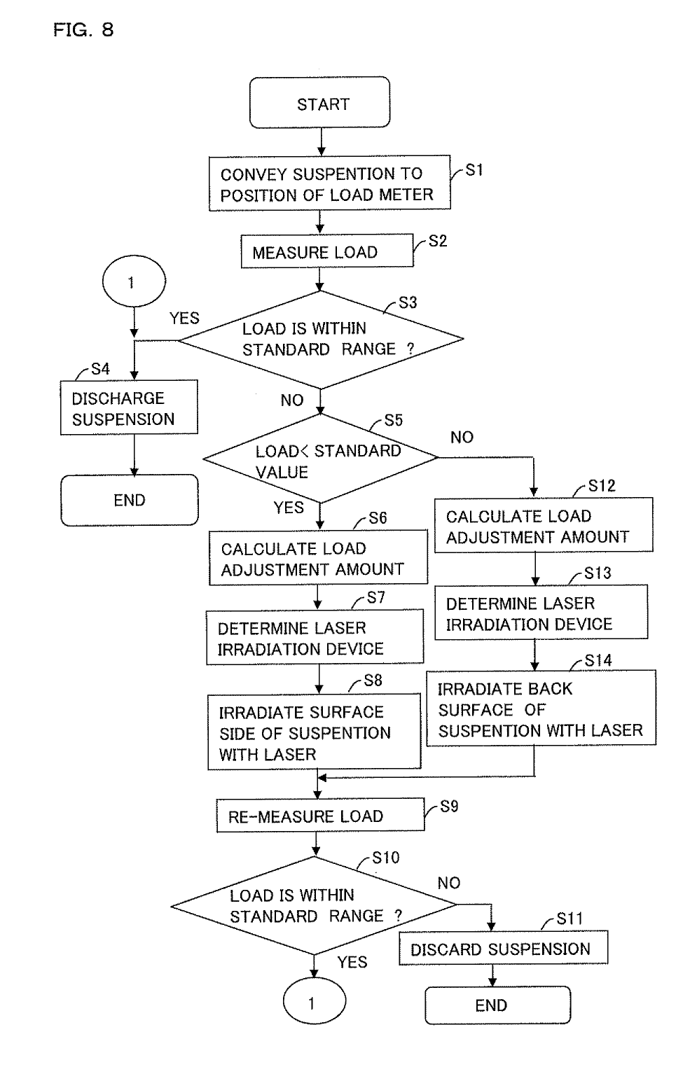

FIG. 8 is an explanatory diagram of load adjustment process.

In advance, the suspension 4 before spring load adjustment is manufactured. Then, load adjustment processing is performed regarding the suspension 4 manufactured as a unit of manufacturing process of the suspension 4. The load adjustment processing is described below.

First, the suspension 4 to be measured, which has been set on the fixing unit 5, is set at an initial position on the conveying unit 6 by a robot or the like. When the conveying unit 6 detects the loaded suspension 4, it conveys the suspension 4 from the initial position to a position of the load meter 7 (step S1).

Next, a load on the suspension 4 is measured (step S2). Then, it is checked whether the load is within a standard range (step S3).

If the load is within the standard range, no adjustment is needed, and so an instruction to discharge the suspension 4 set on the fixing unit 5 is provided, upon which the robot or the like discharges the suspension 4 (step S4). Thus, the manufactured suspension 4 is used for manufacturing of the actuator 51. On the other hand, the load is without the standard range, an adjustment is needed.

Next, it is checked whether the load is lower than a standard value (step S5). If so, a load adjustment amount is calculated in a direction in which the load increases (step S6).

The adjustment amount is determined as difference between the standard value and the acquired load value.

Next, laser irradiation devices 10 to be used, of the surface irradiation unit 91 are determined on the basis of the adjustment amount (step S7).

Then, the suspension 4 is conveyed along a predetermined direction by the conveying unit 6.

Upon arrival of the suspension 4, the laser irradiation devices 10 scan the surface side of the suspension 4 and applies laser thereto (step S8).

Next, load on the suspension 4 that has been subjected to load adjustment is re-measured (step S9).

Then, it is checked whether the measured result is within the standard range (step S10). If the measured load is within the standard range, the process goes to step S4, where the suspension 4 is unloaded. If the measured load is without the standard range, the suspension 4 is discarded as a defective, thus ending the process (step S11).

On the other hand, if the checked result in step S3 indicates that the size of the suspension 4 is higher than the standard value, a load adjustment amount is calculated in a direction in which the load decreases (step S12).

The adjustment amount is determined as difference between the standard value and the acquired load value.

Next, laser irradiation devices 20 to be used, of the back-surface irradiation unit 92 are determined on the basis of the adjustment amount (step S13).

Then, after the suspension 4 has been driven toward a predetermined direction, the back surface of the suspension 4 is scanned and irradiated with laser by the determined laser irradiation devices 20 (step S14).

Next, in order to re-measure the load on the suspension 4 that has been subjected to load adjustment, the process goes to step S9.

If measured load is within the standard range, the process goes to step S4. On the other hand, if the measured load is without the standard range, in order to discard the suspension 4 as a defective, the process goes to step S11.

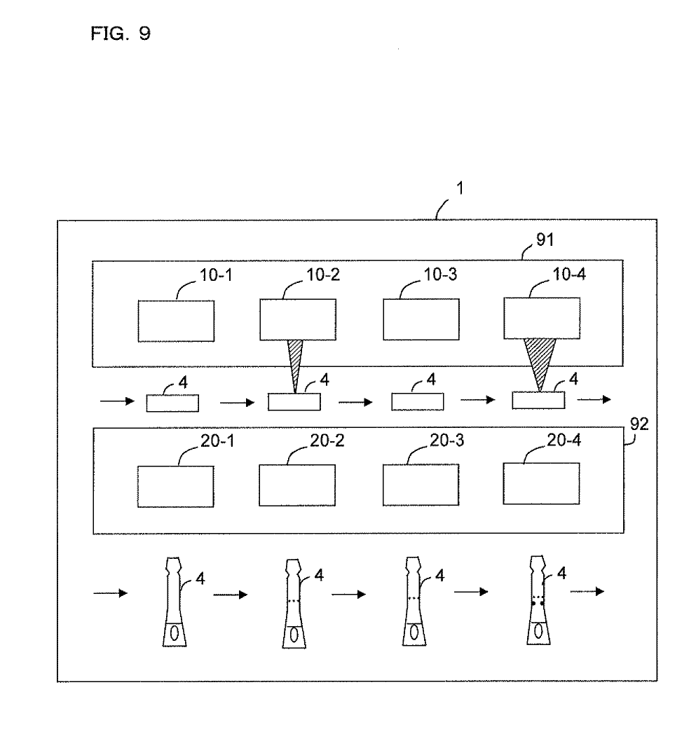

FIG. 9 is a diagram showing a specific example of load correction. This is an example in which a measured value of a load on the suspension 4 is lower than the standard value.

The laser irradiation devices 10 used here consists of four laser irradiation devices. Let the load standard value be, e.g., 1.35 to 1.65 g. Let a laser minimum adjustment amount be 0.1 g. Hence, the adjustment amount of the laser irradiation device 10-1 is taken as 0.1 g. The adjustment amount of the laser irradiation device 10-2 is taken as 0.2 g. The adjustment amount of the laser irradiation device 10-3 is taken as 0.4 g. The adjustment amount of the laser irradiation device 10-4 is taken as 0.8 g.

When a result measured by the load meter 7 is 0.5 g, the adjustment range becomes 0.85 g to 1.15 g, so that they are averaged. The average value is 1 g. Thus, the adjustment load is determined to be 1 g.

Then, the laser irradiation devices 10 are selected. Since the measured value is lower than the standard value, it is necessary to perform irradiation by the surface irradiation unit 91 in order to perform load correction. Specifically, the laser irradiation device 10-2 and the laser irradiation device 10-4 are selected. The laser irradiation device 10-1 and the laser irradiation device 10-3 are not employed.

Irradiation processing in this case is performed in accordance with the following procedures.

The suspension 4 is conveyed by the conveying unit 6 and passes under the laser irradiation device 10-1. At this time, the laser is not applied. The suspension 4 is further conveyed and passes under the laser irradiation device 10-2. At this time, laser is applied and load is adjusted by 0.2 g. The suspension 4 is still further conveyed and passes under the laser irradiation device 10-3. At this time, the laser is not applied. The suspension 4 is further conveyed and passes under the laser irradiation device 10-4. At this time, laser is applied and load is adjusted by 0.8 g. As a result, a load adjustment amount of 1 g is achieved. Here, the laser irradiation devices 20-1 to 20-4 of the back-surface irradiation unit 92 are not used.

By such processing, regarding the load adjustment, it is possible to secure a necessary load adjustment amount while maintaining a set minimum adjustment amount (resolution) only by a combination of a minimum number of laser irradiation devices.

Furthermore, by oppositely arranging the laser irradiation devices 10 and the laser irradiation devices 20, load adjustment in positive/negative direction can be implemented.

Moreover, since the relative positional relationship between the laser irradiation devices 10 and the laser irradiation devices 20, and correction positions of the suspension 4 is definite, stable load adjustment can be implemented.

Besides, since an adjustment within the same process is feasible irrespective of the magnitude of an adjustment amount of the suspension 4, load adjustment in definite takt time can be achieved.

Furthermore, since laser is sequentially applied along the direction from the flexure 38 side toward the spacer unit 33, it is possible to apply laser to a flat unit on the load beam 32, thereby allowing an improvement in load adjustment accuracy.

Moreover, by using the n-laser irradiation devices the have irradiation amounts from a minimum load adjustment amount multiplied by 2⁰ to minimum adjustment amounts multiplied by 2⁽ⁿ⁻¹⁾ (where n is a positive integer) and that have respective defined irradiated positions, laser irradiation conditions can be easily set. This eliminates the need to set, with respect to a single laser irradiation device, laser irradiation conditions by combining complicated condition parameters concerning the irradiation amount, the irradiated position, and the like.

The spring member manufacturing device 1 can be used not only when load adjustment is performed with respect to the suspension 4 that has already been subjected to bending by machining, but also when bending work is to be performed with respect to the suspension 4 that has not yet been subjected to bending, in order to obtain a predetermined spring load.

What is claimed is:

1. A spring member manufacturing device for manufacturing the spring member, the spring member manufacturing device comprising:
a laser irradiation apparatus including a plurality of laser irradiation devices for performing predetermined laser irradiation with respect to the spring member,
the laser irradiation devices being arranged to eliminate overlap with respective irradiated position on the spring member,
the laser irradiation devices having preset laser irradiation condition different from each other, the irradiation condition being 2 to the (n−1)th power, n being a positive integer of predetermined minimum adjustment amount for adjusting load on the spring member,
combination of the laser irradiation devices being selected in accordance with load adjusting amount required for the spring member.

2. The spring member manufacturing device according to claim 1, wherein the laser irradiation apparatuses are arranged on each of the surface side and the back surface side of the spring member so that the plurality of laser irradiation devices can apply laser to each of the surface and the back surface of the spring member.

3. The spring member manufacturing device according to claim 1, further comprising:
a movement mechanism that moves the spring member along predetermined direction in which the laser irradiation devices are arranged, at a definite speed with respect to all of the first to n-th laser irradiation devices,
wherein the spring member is subjected to laser irradiation along predetermined irradiated positions of the respective laser irradiation devices by sequentially passing through the respective laser irradiation devices by the movement of the spring member by the movement mechanism.

4. The spring member manufacturing device according to claim 1, further comprising:
a movement mechanism that moves the spring member along predetermined direction in which the laser irradiation devices are arranged, at speeds set in correspondence with the respective first to n-th laser irradiation devices,
wherein the spring member is subjected to laser irradiation along the predetermined irradiated positions of the respective laser irradiation devices by sequentially passing through the respective laser irradiation devices by the movement of the spring member by the movement mechanism.

5. The spring member manufacturing device according to claim 1, further comprising:
a load meter that measures the load on the spring member; and
a control unit that determines a load adjustment amount on the basis of the difference between the load measured by the load meter and a target load, that selects a combination of the laser irradiation devices according to the adjustment amount, and that controls laser irradiation with respect to the spring member by the selected laser irradiation devices.

6. The spring member manufacturing device according to claim 1, wherein the spring member is a suspension mounting thereon a head slider of a magnetic disk device.

7. The spring member manufacturing device according to claim 2, further comprising:
a movement mechanism that moves the spring member along predetermined direction in which the laser irradiation devices are arranged, at a definite speed with respect to all of the first to n-th laser irradiation devices,
wherein the spring member is subjected to laser irradiation along predetermined irradiated positions of the respective laser irradiation devices by sequentially passing through the respective laser irradiation devices by the movement of the spring member by the movement mechanism.

8. The spring member manufacturing device according to claim 2, further comprising:
a movement mechanism that moves the spring member along predetermined direction in which the laser irradiation devices are disposed, at speeds set in correspondence with the respective first to n-th laser irradiation devices,
wherein the spring member is subjected to laser irradiation along the predetermined irradiated positions of the respective laser irradiation devices by sequentially passing through the respective laser irradiation devices by the movement of the spring member by the movement mechanism.

9. The spring member manufacturing device according to claim 2, further comprising:
a fixing unit that supports one edge of the spring member as a fixed edge,
wherein the laser irradiation devices are arranged in correspondence with a plurality of laser irradiated positions on the spring member, and the laser irradiation devices are arranged so that laser is sequentially applied from farthest laser irradiation position to nearest laser irradiation position from the fixed edge.

10. A method for manufacturing a spring member comprising,
providing a laser irradiation apparatus including a plurality of laser irradiation devices for performing predetermined laser irradiation with respect to the spring member, the laser irradiation devices being arranged to eliminate overlap with respective irradiated position on the spring member, the laser irradiation devices having preset laser irradiation condition different from each other,the irradiation condition being 2 to the (n−1)th power, n being a positive integer,of predetermined minimum adjustment amount for adjusting load on the spring member, the combination of laser irradiation devices being selected in accordance with load adjusting amount required for the spring member; and
manufacturing the spring member by laser irradiation of the selected laser irradiation devices.

11. A spring member manufacturing method by which a load on the spring member is adjusted by laser irradiation of a plurality of laser irradiation devices, the spring member manufacturing method comprising the steps of:
measuring a load on the spring member;
acquiring a load adjustment amount on the basis of the difference between the measured load and a target load;
selecting the laser irradiation devices according to the acquired load adjustment amount, each of the laser irradiation devices having different laser irradiation amounts of 2 to the (n−1)th power, n being a positive integer, of predetermined minimum adjustment amount for adjusting the load on the spring member; and
applying laser to the spring member by the selected laser irradiation devices.

12. The spring member manufacturing method according to claim 11, wherein the step of applying includes sequentially applying the laser toward a plurality of predetermined irradiated positions along predetermined direction on the spring member, by the laser irradiation devices arranged in correspondence with the plurality of laser irradiated positions on the spring member.
